(19) United States
(12) Patent Application Publication
(10) Pub. No.: US 2026/0116026 A1
(43) Pub. Date: Apr. 30, 2026

(54) EQUIPMENT AND METHOD FOR PULTRUSION MOLDING

(71) Applicants: Hyundai Motor Company, Seoul (KR); Kia Corporation, Seoul (KR)

(72) Inventors: Jin Gyo SUH, Hwaseong-Si (KR); Kun Wook LEE, Hwaseong-Si (KR); Kyu Young LEE, Hwaseong-Si (KR); Hyun Yi KWON, Hwaseong-Si (KR); Jun Sik CHOI, Hwaseong-Si (KR)

(21) Appl. No.: 19/209,454

(22) Filed: May 15, 2025

(30) Foreign Application Priority Data
Oct. 29, 2024 (KR) 10-2024-0149145

(51) Int. Cl. B29C 70/52; B29C 70/08; B29C 70/54

(52) U.S. Cl. CPC B29C 70/523; B29C 70/081; B29C 70/54

(57) ABSTRACT

Proposed are an apparatus and a method for pultrusion molding. The pultrusion molding apparatus may include a fiber yarn and nonwoven fabric dispensers, and a resin impregnation die with an impregnation chamber. A fiber yarn and a nonwoven fabric, supplied from the respective dispensers, and resin may be injected into the impregnation chamber. The resin impregnation chamber may discharge a composite material of the fiber yarn and the nonwoven fabric, impregnated with the resin. The apparatus may further include a pultrusion molding die configured to: apply heat and pressure to the composite material, and mold and discharge the composite material into a first product having a predetermined cross-sectional shape. The apparatus may further include a bender configured to bend, using a plurality of rollers, the first product into a second product having a curvature; and an extractor configured to pull and extract, from the bender, the second product.

### CROSS REFERENCE TO RELATED APPLICATION

The present application claims priority to Korean Patent Application No. 10-2024-0149145, filed on Oct. 29, 2024, the entire contents of which are incorporated herein by reference for all purposes.

### TECHNICAL FIELD

The present disclosure relates to an apparatus and method for pultrusion molding, and more specifically an apparatus and method for pultrusion-molding vehicle body parts.

### BACKGROUND

In general, plastic composite materials are highly regarded as one of the key materials for components in the aerospace and automotive industries due to their excellent strength, elasticity, light weight, and stability.

For example, plastic composite materials, such as a carbon-fiber reinforced plastic (CFRP, also referred to as a carbon-fiber reinforced polymer), a glass-fiber reinforced plastic (GFRP, also referred to as a glass-fiber reinforced polymer or fiberglass), etc., are used as body materials of vehicles to achieve high strength and light weight.

Car body parts made of these plastic composite materials can be manufactured by a pultrusion molding machine employing a pultrusion molding process.

Pultrusion molding, which is a method of continuously molding a product with a constant cross-section in the longitudinal direction, offers superior productivity and high tensile strength of molded products in comparison to other molding processes, such as sheet molding compound (SMC) and prepreg compression molding (PCM). Thus, pultrusion molding is considered one of the manufacturing processes that are suitable for molding car body parts.

A pultrusion molding process by pultrusion molding machines may involve impregnating a plastic composite material of two or more types of materials with resin, molding a product with a predetermined shape by applying heat and pressure to the plastic composite impregnated with resin, pulling an extracting the molded product, and cutting the extracted product to a predetermined length.

However, the configuration and operation characteristics of pultrusion molding machines may be limited to pultrusion-molding only straight car body parts, and producing curved plastic composite car body parts that have a curvature, which account for a majority of car body parts, may pose special challenges.

### SUMMARY

The present disclosure has been made in an effort to solve the problems described above, and an objective of the present disclosure is to provide equipment and method for pultrusion molding, the equipment and method being able to easily manufacture car body parts of plastic composite materials by continuously performing a process in which resin is impregnated into a plastic composite of two or more types of materials by a resin impregnation die and a process in which the plastic composite impregnated with resin is fed into a pultrusion molding die and molded into a product with a predetermined cross-sectional shape by heat and pressure, and then by making it possible to bend the molded product with the predetermined cross-sectional shape into a car body part having varying curvatures using at least three or more pairs of rollers.

According to one or more example embodiments of the present disclosure, a pultrusion molding apparatus may include: a fiber yarn dispenser configured to supply a fiber yarn; a nonwoven fabric dispenser configured to supply a nonwoven fabric; and a resin impregnation die forming an impregnation chamber therein. One or more resin injection holes may be formed through the resin impregnation die. The resin impregnation die may be configured to: receive the fiber yarn that is supplied from the fiber yarn dispenser and injected into the impregnation chamber; receive the nonwoven fabric that is supplied from the nonwoven fabric dispenser and injected into the impregnation chamber; receive, through the one or more resin injection holes, resin that is injected into the impregnation chamber; and discharge a composite material, of the fiber yarn and the nonwoven fabric, that is impregnated with the resin. The pultrusion molding apparatus may further include: a pultrusion molding die configured to: apply heat and pressure to the composite material discharged from the resin impregnation die; and mold and discharge the composite material into a first product having a predetermined cross-sectional shape; and a bender including a plurality of rollers arranged to be movable laterally with respect to a direction of discharge of the first product from the pultrusion molding die. The bender may be configured to bend, using the plurality of rollers, the first product discharged from the pultrusion molding die into a second product having a curvature. The pultrusion molding apparatus may further include an extractor configured to pull and extract, from the bender, the second product.

The fiber yarn dispenser may include: one or more rollers on which at least one of a carbon fiber yarn or a glass fiber yarn is wound; and a stand on which the one or more rollers are stacked.

The nonwoven fabric dispenser may include: one or more rollers on which glass fiber nonwoven fabric is wound; and a stand on which the one or more rollers are stacked.

The resin impregnation die may include: an upper block forming an upper impregnation chamber, of the impregnation chamber, therein; a lower block forming a lower impregnation chamber, of the impregnation chamber, therein; and a mandrel positioned to be movable between the upper impregnation chamber of the upper block and the lower impregnation chamber of the lower block. The one or more resin injection holes may include an upper resin injection hole and a first side resin injection hole that are formed on the upper block and connected to the upper impregnation chamber. The one or more resin injection holes may include a lower resin injection hole and a second side resin injection hole that are formed on the lower block and connected to the lower impregnation chamber.

The mandrel may include a material feed guide block that is flush with at least one side of the upper block.

An upper material feed hole, connected to the upper impregnation chamber, may be formed between a top surface of the material feed guide block and a top surface of the upper block. A lower material feed hole, connected to the lower impregnation chamber, may be formed between a bottom surface of the material feed guide block and a top surface of the lower block.

The pultrusion molding apparatus may further include: a controller; and a position sensor mounted on the mandrel. The position sensor may be configured to transmit, to the controller, a detection signal indicating a position of the mandrel.

The controller may be configured to: control, based on the detection signal received from the position sensor, a driving speed of a plurality of resin supply pumps that are respectively connected to the upper resin injection hole, the first side resin injection hole, the lower resin injection hole, and the second side resin injection hole, such that resin pressures, for injecting the resin into the upper resin injection hole, the first side resin injection hole, the lower resin injection hole, and the second side resin injection hole, are independently adjusted.

The pultrusion molding die may include: an upper die forming an upper cavity below the upper die; and a lower die forming a lower cavity above the lower die. The pultrusion molding die may be configured to apply, while the composite material impregnated with the resin passes through the upper cavity and the lower cavity, heat and pressure to the composite material impregnated with the resin.

The bender may further include a plurality of roller rails successively arranged in the direction of discharge of the first product. A pair of rollers, of the plurality of rollers, may be fastened to each roller rail of the plurality of roller rails to be movable along the roller rail. The bender may further include a plurality of electric cylinders. Each electric cylinder, of the plurality of electric cylinders, may be: mounted at each end of each of the plurality of roller rails; connected to a corresponding roller, of the plurality of rollers; and configured to move, based on a control signal received from a controller, the corresponding roller along a corresponding roller rail of the plurality of roller rails.

The pultrusion molding apparatus may further include a controller. The plurality of roller rails may include a first roller rail, a second roller rail, and a third roller rail. The second roller rail may be arranged between the first roller rail and the third roller rail. The bender may further include one or more stress sensors mounted on the pair of rollers fastened to the second roller rail. The one or more stress sensors may be configured to: measure an amount of stress exerted by the pair of rollers against the first product discharged from the pultrusion molding die; and transmit, to the controller, a signal indicating the amount of the stress.

The controller may be configured to control, based on the signal from the one or more stress sensors, a driving speed of the plurality of electric cylinders to adjust a movement speed of the pair of rollers in a direction of bending the first product.

The controller may be further configured to perform at least one of: based on the amount of the stress indicated by the signal from the one or more stress sensors exceeding a reference range, decreasing the driving speed of the plurality of electric cylinders to decrease the movement speed of the pair of rollers; or, based on the amount of the stress indicated by the signal from the one or more stress sensors being less than the reference range, increasing the driving speed of the plurality of electric cylinders to increase the movement speed of the pair of rollers.

The plurality of electric cylinders may include piston rods. The controller may be further configured to maximally move backward the piston rods such that each roller of the pair of rollers is maximally moved backward at a time that the first product finishes being bent into the second product having the curvature.

The extractor may include: an upper clamp and a lower clamp configured to clamp a first portion of the second product; a fixed frame mounted at both sides of the lower clamp and positioned over the upper clamp; an elevation cylinder connected between the fixed frame and the upper clamp and configured to move up and down the upper clamp; guide rails to which a bottom of the lower clamp is fastened to be movable; and a linear actuator fastened to the lower clamp and configured to move the lower clamp.

According to one or more example embodiments of the present disclosure, a method performed by a pultrusion molding machine may include: impregnating, with resin, a composite material including a fiber yarn and nonwoven fabric; molding the composite material impregnated with the resin, by applying heat and pressure to the composite material impregnated with the resin, into a first product having a predetermined cross-sectional shape; bending, using a bender that has a plurality of rollers arranged to be movable laterally, the first product, molded to have the predetermined cross-sectional shape, into a second product having a curvature; and pulling and extracting, from the bender, the second product.

Bending may include, after the first product, molded to have the predetermined cross-sectional shape, passes between the plurality of rollers and is pressed between the plurality of rollers, moving the plurality of rollers in different directions.

The method may further include: measuring, via one or more stress sensors mounted on the plurality of rollers, an amount of stress exerted by the plurality of rollers against the first product.

The method may further include: controlling, via a controller and based on the amount of stress indicated by a signal received from the one or more stress sensors, a movement speed of the plurality of rollers in a direction of bending the first product.

The method may further include one of: controlling, via the controller and based on the amount of the stress indicated by the signal received from the one or more stress sensors exceeding a reference range, the movement speed of the plurality of rollers to be decreased by a predetermined level; or controlling, via the controller and based on the amount of the stress indicated by the signal received from the one or more stress sensors being less than the reference range, the movement speed of the plurality of rollers to be increased by the predetermined level.

### BRIEF DESCRIPTION OF THE DRAWINGS

FIG. 1 is a perspective view showing an example apparatus for pultrusion molding;

FIG. 2 is a perspective view showing a resin impregnation die and a pultrusion molding die of an example apparatus for pultrusion molding;

FIG. 3 is a perspective view showing an operation in which fiber and nonwoven fabric are fed into the resin impregnation die of an example apparatus for pultrusion molding;

FIG. 4 is a cross-sectional view showing a process in which a product with a predetermined cross-sectional shape is molded in the pultrusion molding die after the fiber and nonwoven fabric are fed into the resin impregnation die of an example apparatus for pultrusion molding;

FIG. 5 is a perspective view showing an operation in which a product discharged from a pultrusion molding die is bent with a predetermined curvature by a bender of an example apparatus for pultrusion molding;

FIG. 6 is a perspective view showing an operation in which the product discharged from the pultrusion molding die is extracted from the bender by an extractor after being bent with a predetermined curvature by the bender of an example apparatus for pultrusion molding; and

FIG. 7 and FIG. 8 are flowcharts showing an example method for pultrusion molding.

### DETAILED DESCRIPTION

Description of specific structures and functions disclosed in embodiments of the present disclosure is only an example for describing the embodiments according to the concept of the present disclosure and the embodiments according to the concept of the present disclosure may be implemented in various ways. The present disclosure is not limited to the embodiments described herein and should be construed as including all changes, equivalents, and replacements that are included in the spirit and the range of the present disclosure.

It will be understood that, although the terms “first,” “second,” etc. may be used herein to describe various elements, these elements should not be limited by these terms. These terms are used only to distinguish one element from another element and do not necessarily imply special order, temporal order, priority, or preference. For instance, a first element discussed below could be termed a second element without departing from the right range of the present disclosure. Similarly, the second element could also be termed the first element.

It is to be understood in the specification that when one element is referred to as being “connected to” or “coupled to” another element, it may be connected directly to or coupled directly to another element or be connected to or coupled to another element having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent”, or “directly adjacent” should be interpreted in the same manner as those described above.

Like reference numerals indicate the same components throughout the specification. The terms used herein are provided to describe embodiments without limiting the present disclosure. In the specification, a singular form includes a plural form unless specifically stated in the sentences. The terms “comprise” and/or “comprising” used herein do not exclude that another component, step, operation, and/or element exist or are added in the stated component, step, operation, and/or element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, one or more example embodiments of the present disclosure will be described in detail with reference to the accompanying drawings.

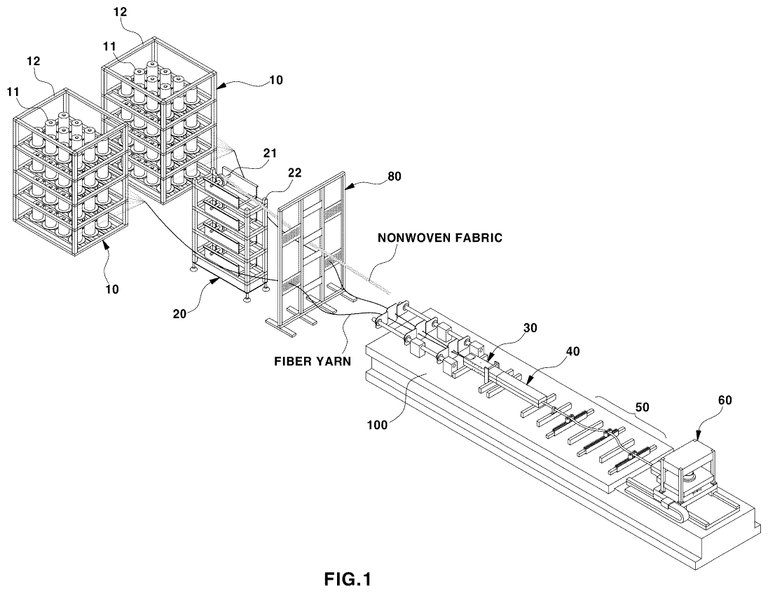

The accompanying FIG. 1 is a perspective view showing an example apparatus for pultrusion molding.

Referring to FIG. 1, equipment (also referred to as an apparatus, a machine, etc.) for pultrusion molding according to the present disclosure may include a fiber yarn supplier 10, a nonwoven fabric supplier 20, a resin impregnation die 30, a pultrusion molding die 40, a bender 50, and an extractor 60.

The fiber yarn supplier 10 may include one or more first rollers 11. A carbon fiber or glass fiber yarn may be wound on the one or more first rollers 11. The fiber yarn supplier 10 may further include a first stand 12. The one or more first rollers 11 may be stacked on the first stand 12. Multiple first rollers 11 may be stacked, for example, at regular intervals.

The carbon fiber or glass fiber yarn may be unwound from the first rollers 11 and be supplied to the resin impregnation die 30.

The nonwoven fabric supplier 20 may include one or more second rollers 21. Glass fiber nonwoven fabric may be wound on the one or more second rollers 21. The nonwoven fabric supplier 20 may further include a second stand 22. The one or more second rollers 21 may be stacked on the nonwoven fabric supplier 20. Multiple second rollers 21 may be stacked, for example, at regular intervals. The rollers 11 and/or the rollers 21 may be, for example, one or more of spools, bobbins, reels, spindles, cylinders, dispensers, etc.

The nonwoven fabric may be unwound from the second rollers 22 and be supplied to the resin impregnation die 30.

A guide frame 80 for guiding a fiber yarn in the supply direction and guiding nonwoven fabric in the supply direction may be disposed at the front of the fiber yarn supplier 10 and the nonwoven fabric supplier 20 (e.g., disposed between the fabric supplier 20 and the resin impregnation die 30).

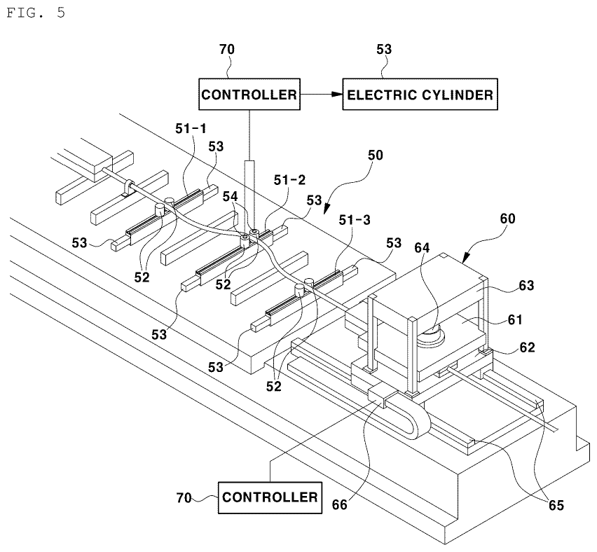

The resin impregnation die 30, as shown in FIG. 4, may have a structure that has, therein, impregnation spaces (also referred to as impregnation chambers) 31-3 and 32-3, into which the fiber yarn supplied from the fiber yarn supplier 10 and the nonwoven fabric supplied from the nonwoven fabric supplier 20 are fed. In other words, the fiber yarn, the nonwoven fabric, and the resin may be received by the resin impregnation die 30 and injected into the impregnation spaces. The resin impregnation die 30 may have resin injection holes 31-1, 31-2, 32-1, and 32-2 for injecting resin into the impregnation spaces 31-3 and 32-3.

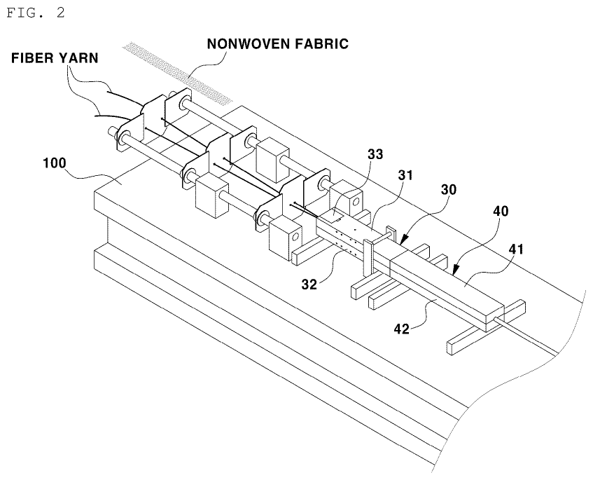

The resin impregnation die 30, as shown in FIG. 2, may be composed of an upper block 31 and a lower block 32 stacked on top of each other over a table 100. A mandrel 33 may be movably disposed between the upper block 31 and the lower block 32.

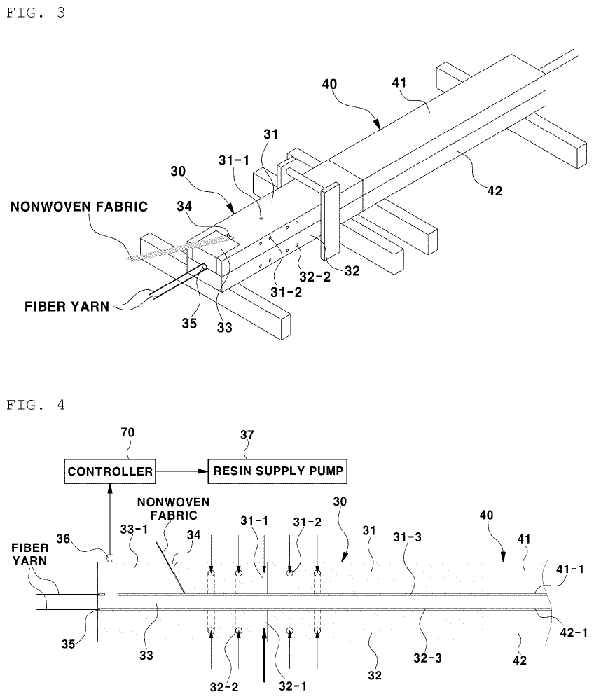

The lower block 31 of the resin impregnation die 30, as shown in FIG. 3 and FIG. 4, may have a structure in which an upper impregnation space (also referred to as an upper impregnation chamber) 31-3 is formed, an upper resin injection hole 31-1 connected with the upper impregnation space 33-3 is formed at the upper portion thereof, and one or more first side resin injection holes 31-2 connected with the upper impregnation space 33-3 are formed. The one or more first side resin injection holes 31-2 may be formed, for example, on both sides of the resin impregnation die 30.

The lower block 32 of the resin impregnation die 30, as shown in FIG. 3 and FIG. 4, may have a structure in which a lower impregnation space (also referred to as a lower impregnation chamber) 32-3 is formed, a lower resin injection hole 32-1 connected with the lower impregnation space 32-3 is formed at the lower portion thereof, and one or more second side resin injection holes 32-2 connected with the lower impregnation space 32-3 are formed. The one or more second side resin injection holes 32-2 may be formed, for example, on both sides of the resin impregnation die 30.

A resin supply pump 37 for supplying resin may be connected to each of the upper resin injection hole 31-1 and the one or more first side resin injection holes 31-2 of the upper block 31. A resin supply pump 37 for supplying epoxy resin may also be connected to each of the lower resin injection hole 32-1 and the second side resin injection holes 32-2 of the lower block 32.

The mandrel 33 may have a bar shape having a circular or rectangular cross-section. The mandrel 33 may be movably positioned between the upper impregnation space 31-3 of the upper block 31 and the lower impregnation space 32-3 of the lower block 32.

A material feed guide block 33-1 that is on the same plane with the front and the top of the upper block 31 (e.g., level or flush with at least one side of the upper block 31) may be integrally formed at the front end portion of the mandrel 33.

Since the material feed guide block 33-1 is integrally formed at the front end portion of the mandrel 33, an upper material feed hole 34, which connects to the upper impregnation space 31-3, may be formed between the top surface of the guide block 33-1 of the mandrel 33 and the top surface of the upper block 31. A lower material feed hole 35 connecting to the lower impregnation space 32-3 may be formed between the bottom surface of the material feed guide block 33-1 and the top surface of the lower block 32.

The carbon fiber or glass fiber yarn unwound from the first rollers 11 of the fiber yarn supplier 10 may be supplied to the lower impregnation space 32-3 through the lower material feed hole 35. The glass fiber nonwoven fabric unwound from the second rollers 21 of the nonwoven fabric supplier 20 may be supplied to the upper impregnation space 31-3 through the upper material feed hole 34.

A position sensor 36 may be mounted at a predetermined position on the mandrel 33. The position sensor 36 may detect up-down (e.g., vertical) position changes and left-right (e.g., lateral or horizontal) position changes of the mandrel 33 and transmit detection signals to a controller 70.

The controller 70 may be configured to control the driving speed of the resin supply pumps 37 respectively connected to the upper resin injection hole 31-1, the first side resin injection holes 31-2, lower resin injection hole 32-1, and the second side resin injection holes 32-2. The controller 70 may be configured to control the driving speed based on a detection signal indicating the position sensor 36 such that resin pressures, for injecting resin into the upper resin injection hole 31-1, the first side resin injection holes 31-2, lower resin injection hole 32-1, and the second side resin injection holes 32-2, may be separately (e.g., independently) adjusted. The following are examples of the driving speeds of the resin supply pumps 37 and the resin injection pressures being adjusted in accordance with up-down (e.g., vertical) position changes and/or left-right (e.g., lateral or horizontal) position changes of the mandrel 33.

The pultrusion molding die 40 may be disposed over the table 100. The pultrusion molding die 40 may be configured to mold a composite material, which is impregnated with resin (e.g., carbon fiber or glass fiber yarn +glass fiber nonwoven fabric +resin) and discharged from the resin impregnation die 30, into a product (e.g., a first product) having a predetermined cross-sectional shape. The pultrusion molding die 40 may be configured to mold the composite material by applying heat and pressure to the composite material.

The pultrusion molding die 40, as shown in FIG. 3 and FIG. 4, may include an upper die 41 having an upper cavity 41-1 formed below the bottom surface of the upper die 41, and a lower die 42 having a lower cavity 42-1 formed above the lower die 42, in which heating lines, etc., though not shown, may be embedded in the upper die 41 and the lower die 42.

When (e.g., while or after) a composite material impregnated with resin discharged from the resin impregnation die 30 passes through the upper cavity 41-1 of the upper die 41 and the lower cavity 42-1 of the lower die 42, heat and pressure may be applied to the composite material impregnated with resin, whereby the composite material impregnated with resin may be pultrusion-molded into a product with a predetermined cross-sectional shape.

The bender 50 may include one or more rollers. The bender 50 may be configured to bend a product that is discharged from the pultrusion molding die 40 into a car body part having a curvature using the one or more rollers (e.g., at least three pairs of rollers) arranged to be movable left and right (e.g., laterally). For example, each of the plurality of rollers (e.g., each pair of rollers of the plurality of rollers) may be movable in a lateral direction relative to (e.g., perpendicular to) the direction of pultrusion (e.g., discharge) of the product from the pultrusion molding die 40. While throughout the present disclosure, the product that is generated by and discharged from the bender 50 is referred to as a car body part, the present disclosure is not limited thereto. For example, the bender 50 may bend a product that is discharged from the pultrusion molding die 40 into any product that is composed of a composite material impregnated with resin for any use, other than for use in a vehicle.

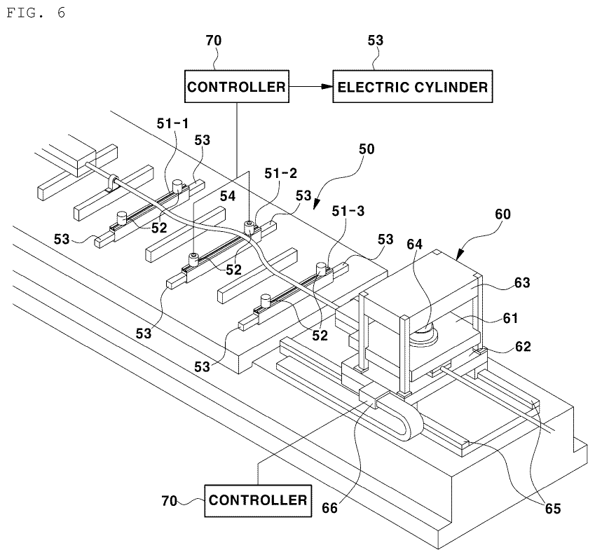

The bender 50, as shown in FIGS. 1 and 5, may be composed of one or more (e.g., at least three) roller rails 51 that are, for example, arranged at regular intervals on the table 100 in the front-rear direction (e.g., the direction of pultrusion or discharge of the product from the pultrusion molding die 40). The bender 50 may be further composed of a pair of rollers 52 fastened to each of the roller rails 51 to be movable left and right (e.g., laterally or horizontally). The pair of rollers 52 may bend a product discharged from the pultrusion molding die 40 into a predetermined curvature. The bender 50 may be further composed of an electric cylinder 53 mounted at each of both ends of each of the roller rails 51 and connected to each roller of the pairs of rollers 52.

The roller rails 51 may be composed of a first roller rail 51-1, a second roller rail 51-2, and a third roller rail 51-3 disposed in the left-right direction and arranged (e.g., at regular intervals) successively in the front-rear direction (e.g., in the direction of discharge of the first product) on the table 100, and a pair of rollers 52 is fastened to be movable left and right to each of the first roller rail 51-1, the second roller rail 51-2, and the third roller rail 51-3.

Piston rods of the electric cylinders 53 and shafts of the rollers 52 that extend in the roller rails 51, respectively, may be connected to each other, and in this state, the electric cylinders 53 may be driven in response to a control signal of the controller 70 and the piston rods may be moved forward and/or backward, whereby the rollers 52 can be moved left or right (e.g., laterally) along the roller rails 51, respectively.

Accordingly, a car body part having varying curvatures in the longitudinal direction can be made through a process in which a long straight product discharged from the pultrusion molding die 40 enters between the pair of rollers 52 fastened to the first roller rail 51-1, the pair of rollers 52 fastened to the second roller rail 51-2, and the pair of rollers 52 fastened to the third roller rail 51-3 and a process in which the pair of rollers 52 fastened to the first roller rail 51-1, the pair of rollers 52 fastened to the second roller rail 51-2, and the pair of rollers 52 fastened to the third roller rail 51-3 bend the long straight product to a predetermined curvature while moving in different directions.

A stress sensor 54 may detect (e.g., measure) an amount of stress (e.g., pressure) of the pair of rollers 52, fastened to the second roller rail 51-2 to be movable left and right, exerting against a product discharged from the pultrusion molding die 40. The stress sensor 54 may be mounted on each of the pair of rollers 52.

The controller 70 may be configured to control the driving speed of the electric cylinders 53 based on detection signals from the stress sensors 54 to increase or decrease the movement speeds of the pair of rollers 52 in the direction for bending a product.

For example, if stress detected by the stress sensors 54 exceeds a threshold value, such as the maximum of a reference range (e.g., 30 kN-50 kN), the controller 70 may control the driving speed of the electric cylinders 53, that is, the speed at which the piston rods are moved forward or backward to decrease, whereby the movement speed of the pair of roller 52 in the bending direction can be reduced by a predetermined level. Accordingly, the stress when the pair of rollers 52 presses against a product discharged from the pultrusion molding die 40 in the bending direction can be adjusted within the reference range.

Accordingly, it may be possible to prevent occurrence of cracks in a product and other product defects due to cracks when the stress, which is generated when the rollers 52 press against the product discharged from the pultrusion molding die 40 while moving in the bending direction, exceeds a threshold value (e.g., 50 kN, which may be the maximum of the reference range).

If stress detected by the stress sensors 54 is less than a threshold value, such as the minimum of the reference range (e.g., 30 kN-50 kN), the driving speed of the electric cylinders 53, that is, the controller 70 may the speed at which the piston rods are moved forward or backward to increase, whereby the movement speed of the pair of roller 52 in the bending direction can be increased by a predetermined level. Accordingly, the stress when the pair of rollers 52 presses against a product discharged from the pultrusion molding die 40 in the bending direction can be adjusted within the reference range.

In other words, if the movement speed of the pair of rollers 52 in the bending direction is excessively low, a product discharged from the pultrusion molding die 40 may be cooled and hardened before it is bent. Accordingly, by increasing the movement speed of the pair of rollers 52 in the bending direction by a predetermined level, as described above, it may be possible to more easily bend a product discharged from the pultrusion molding die 40 to a desired curvature before the product is cooled and hardened.

After a product discharged from the pultrusion molding die 40 finishes being bent into a car body part or any other product having a curvature, the controller 70 controls the piston rods of the electric cylinders 53 to maximally move backward such that each of the pair of rollers 52 maximally moves backward.

With each of the pair of rollers 52 maximally moved backward, the car body part or any other product having a curvature can be easily extracted from the bender 50 by the extractor 60 without interference that is contact with the rollers 52.

The extractor 60 may be configured to pull and extracts a car body bent by the bender 50 from the bender.

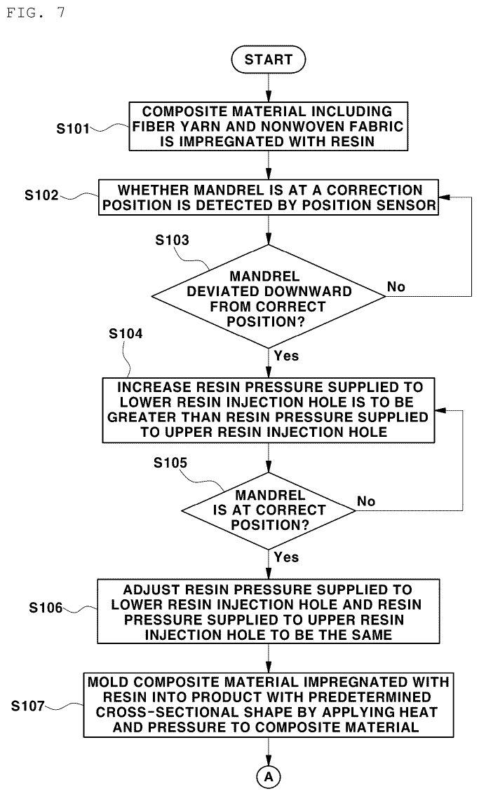

To this end, the extractor 60, as shown in FIG. 5 and FIG. 6, may include: an upper clamp 61 and a lower clamp 62 that clamp the front end portion of a car body part or any other product having a curvature; a fixed frame 63 mounted at both sides of the lower clamp 62 and positioned over the upper clamp 61; an elevation cylinder 64 connected between the fixed frame 63 and the upper clamp 61 and moving up and down the upper clamp 61; guide rails 65 to which the bottom of the lower clamp 62 is fastened to be movable forward and backward on the table 100; and a linear actuator 66 connected to the lower clamp 62 and moving the lower clamp 62 forward and backward.

A car body part or any other product bent by the bender 50 can be easily pulled and extracted from the bender through a process in which the front end portion of the car body part bent by the bender 50, that is, the car body part having a curvature is placed on the lower clamp 62, a process in which the upper clamp 61 is driven by the elevation cylinder 64 to move down and come in contact with the top of the lower clamp 62 while clamping the front end portion of the car body part, and a process in which the lower clamp 62 is driven by the linear actuator 66 to move in the direction of pulling the car body part having a curvature along the guide rails 65.

When (e.g., while or after) the lower clamp 62 is driven by the linear actuator 66 to move in the direction of pulling the car body part or any other product having a curvature along the guide rails 65, the upper clamp 61 can also be moved in the same direction because the upper clamp 61 and the lower clamp 62 are coupled to each other by the fixed frame 63 and the elevation cylinder 64.

The car body part, that is, the car body par having a curvature pulled and extracted from the bender 50 by the extractor 60 may be cut by a cutter, whereby the car body part can be completed into a final product.

A method for pultrusion molding of the present disclosure that is performed on the basis of the configuration described above is described hereafter. It is noted that the various steps that are described in reference to the example method may be performed in any order. One or more steps described herein may be omitted and one or more additional steps that are not specified may be added before or after any of the steps described herein.

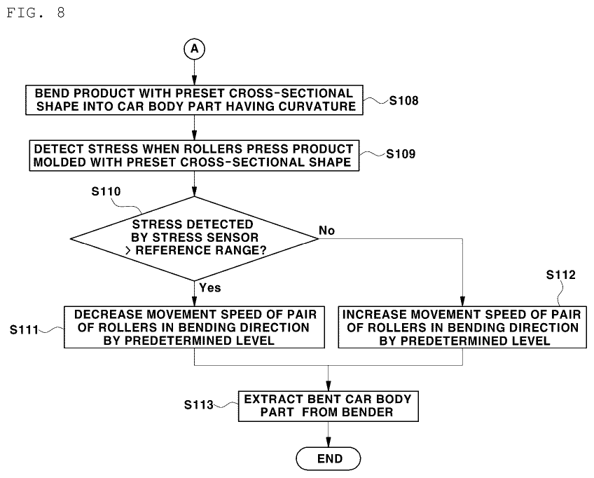

The accompanying FIG. 7 and FIG. 8 are flowcharts showing an example method for pultrusion molding.

A composite material including a fiber yarn and nonwoven fabric may be impregnated with resin in the resin impregnation die 30 (S101).

The carbon fiber or glass fiber yarn unwound from the first rollers 11 of the fiber yarn supplier 10 may be supplied to the lower impregnation space 32-3 through the lower material feed hole 35. The glass fiber nonwoven fabric unwound from the second rollers 21 of the nonwoven fabric supplier 20 may be supplied to the upper impregnation space 31-3 through the upper material feed hole 34.

Epoxy resin may be injected into the upper impregnation space 31-3 and the lower impregnation space 32-3 through the upper resin injection hole 31-1, the first side resin injection holes 31-2, the lower resin injection hole 32-1, and the second side resin injection holes 32-2.

A composite material impregnated with resin (e.g., carbon fiber or glass fiber yarn+glass fiber nonwoven fabric+resin) may be made in the resin impregnation die 30.

The position sensor may detect whether the mandrel 33 is at the correct position (S102). The position sensor may be mounted on the mandrel 33.

The controller 70 may control, based on a detection signal from the position sensor 36, the driving speed of the resin supply pumps 37 respectively connected to the upper resin injection hole 31-1, the first side resin injection holes 31-2, lower resin injection hole 32-1, and the second side resin injection holes 32-2, such that the resin pressures, for injecting resin into the upper resin injection hole 31-1, the first side resin injection holes 31-2, lower resin injection hole 32-1, and the second side resin injection holes 32-2, may be separately and/or independently adjusted.

For example, if the controller 70 determines, based on, for example, a detection signal from the position sensor 36, that the mandrel 33 has deviated downward from (e.g., below the correct position, for example, due to sagging by its own weight (S103), the controller 70 may increase the driving speed of the resin supply pump 37, which supplies resin into the lower resin injection hole 32-1, to be greater than the driving speed of the resin supply pump 37 that supplies resin into the upper resin injection hole 31-1. Thus, the resin pressure supplied to the lower resin injection hole 32-1 may be increased to be greater than the resin pressure supplied to the upper resin injection hole 31-1 (S104), and accordingly, the mandrel 33 can be moved up to the correct position.

If the controller 70 determines, based on, for example, a detection signal from the position sensor 36, that the mandrel 33 is at the correct position (S105), the controller 70 may control the driving speed of the resin supply pump 37 that supplies resin into the lower resin injection hole 32-1 and the driving speed of the resin supply pump 37 that supplies resin into the upper resin injection hole 31-1 to be the same, whereby the resin pressure applied to the lower resin injection hole 32-1 and the resin applied supplied to the upper resin injection hole 31-1 may be adjusted to be the same (e.g., equalized) (S106).

Alternatively, if the controller 70 determines, based on, for example, a detection signal from the position sensor 36, the mandrel 33 has been moved left (e.g., laterally) from the correct position, the controller 70 may increase the driving speed of the resin supply pumps 37 that supply resin to the first side resin injection holes 31-2 and the second side resin injection holes 32-2 at the left side (e.g., a first side) higher than the driving speed of the resin supply pumps 37 supplying resin to the first side resin injection holes 31-2 and the second side resin injection holes 32-2 at the right side (e.g., a second side), thereby being able to move the mandrel 33 to the correct position.

If the mandrel 33 is positioned at the correct position, the upper impregnation space 31-3 and the lower impregnation space 32-3 of the resin impregnation die 30 may be maintained as spaces with a constant thickness (e.g., constant cross-sectional area), and accordingly, a composite material impregnated with resin in a constant thickness (e.g., carbon fiber or glass fiber yarn+glass fiber nonwoven fabric+resin) can be manufactured in the impregnation spaces 31-3 and 32-3 of the resin impregnation die 30.

The composite material impregnated with resin may be molded into a product, for example, with a predetermined cross-sectional shape. The molding can be performed by applying heat and pressure (S107).

When (e.g., while or after) a composite material impregnated with resin discharged from the resin impregnation die 30 passes through the upper cavity 41-1 of the upper die 41 and the lower cavity 42-1 of the lower die 42 of the pultrusion molding die 40, heat and pressure may be applied to the composite material impregnated with resin, whereby the composite material impregnated with resin can be pultrusion-molded into a product with a predetermined cross-sectional shape.

the bender 50 may bend the product, which had been molded into a predetermined cross-sectional shape, into a car body part or any other product having a curvature. The bender 50 may include, for example, at least three pairs of rollers 52 arranged to be movable left and right (e.g., laterally or horizontally) (S108).

The bending may be implemented, as shown in FIG. 5, by moving the pairs of rollers 52 in different directions after the product molded with a predetermined cross-sectional shape enters and is pressed between each of the pairs of rollers 52.

In other words, a car body part or any other product having varying curvatures in the longitudinal direction can be manufactured through a process in which a long straight product discharged from the pultrusion molding die 40 enters between the pair of rollers 52 fastened to the first roller rail 51-1, the pair of rollers 52 fastened to the second roller rail 51-2, and the pair of rollers 52 fastened to the third roller rail 51-3 and a process in which the pair of rollers 52 fastened to the first roller rail 51-1, the pair of rollers 52 fastened to the second roller rail 51-2, and the pair of rollers 52 fastened to the third roller rail 51-3 bend the long straight product to a predetermined curvature while moving in different directions.

In the bending step, the stress sensors 54 mounted on each of the pairs of rollers 52 may detect stress when each of the pairs of rollers 52 presses against a product molded with a predetermined cross-sectional shape (S109).

The controller 70 may compare the stress, which was detected by the stress sensor, with a threshold value (e.g., the reference range) based on the detection signals from the stress sensors 54.

Depending on the comparison result, the movement speed of each of the pairs of rollers 52 in the direction of bending the product may be increased or decreased based on the detection signals from the stress sensors 54.

If the stress detected by the stress sensors 54 exceeds a threshold value (e.g., the reference range) as the comparison result in step S110, the controller 70 may control the movement speed of a pair of rollers 52 to be decreased by a predetermined level (S111).

For example, if stress detected by the stress sensors 54 exceeds a threshold value, such as the maximum of a reference range (e.g., 30 kN-50 kN), the controller 70 may control the driving speed of the electric cylinders 53, that is, the speed at which the piston rods are moved forward or backward, to decrease, whereby the movement speed of a pair of roller 52 in the bending direction may be reduced by a predetermined level. Accordingly, the stress when the pair of rollers 52 presses against a product discharged from the pultrusion molding die 40 in the bending direction can be adjusted within the reference range.

Accordingly, it may be possible to prevent occurrence of cracks in a product and product defects due to cracks when the stress, which is generated when the rollers 52 press against the product discharged from the pultrusion molding die 40 while moving in the bending direction, exceeds 50 kN that is the maximum of the reference range.

If the stress detected by the stress sensors 54 is less than the reference range as the comparison result in step S110, the movement speed of a pair of rollers 52 may be increased by a predetermined level by control of the controller 70 (S112).

For example, if stress detected by the stress sensors 54 is less than a threshold value, such as the minimum of the reference range (e.g., 30 kN-50 kN), the driving speed of the electric cylinders 53, that is, the speed at which the piston rods are moved forward or backward, may be controlled to increase by the controller 70, whereby the movement speed of a pair of roller 52 in the bending direction may be increased by a predetermined level. Accordingly, the stress when the pair of rollers 52 presses against a product discharged from the pultrusion molding die 40 in the bending direction can be adjusted within the reference range.

Accordingly, when the movement speed of the pair of rollers 52 in the bending direction is excessively low, a product discharged from the pultrusion molding die 40 may be cooled and hardened before it is bent. Accordingly, by increasing the movement speed of the pair of rollers 52 in the bending direction by a predetermined level, as described above, it is possible to easily bend a product discharged from the pultrusion molding die 40 to a desired curvature before the product is cooled and hardened.

The bent car body part (or any other product) may be pulled and extracted from the bender 50 (S113).

When (e.g., while or after) the product discharged from the pultrusion molding die 40 finishes being bent into a car body part or any other product having a curvature, the piston rods of the electric cylinders 53 are maximally moved backward and simultaneously a pair of rollers 52 is maximally moved backward.

With the pair of rollers 52 maximally moved backward, the car body part having a curvature can be easily extracted from the bender 50 without interference that is contact with the rollers 52.

In other words, as described above, a car body part bent (or any other product) by the bender 50 can be easily pulled and extracted from the bender through a process in which the front end portion of the car body part bent by the bender 50, that is, the car body part having a curvature is placed on the lower clamp 62, a process in which the upper clamp 61 is driven by the elevation cylinder 64 to move down and come in contact with the top of the lower clamp 62 while clamping the front end portion of the car body part, and a process in which the lower clamp 62 is driven by the linear actuator 66 to move in the direction of pulling the car body part having a curvature along the guide rails 65.

In order to achieve the objectives, an embodiment of the present disclosure provides equipment for pultrusion molding that includes: a fiber yarn supplier; a nonwoven fabric supplier; a resin impregnation die having an impregnation space into which a fiber yarn supplied from the fiber yarn supplier and nonwoven fabric supplied from the nonwoven fabric supplier are fed, and having resin injection holes for injecting resin into the impregnation space; a pultrusion molding die configured to mold a composite material impregnated with resin and discharged from the resin impregnation die into a product with a preset cross-sectional shape by applying heat and pressure to the composite material; a bender configured to bend the product discharged from the pultrusion molding die into a car body product having a curvature using at least three or more pairs of rollers arranged to be movable to the left and right; and an extractor configured to pull and extract the car body part bent by the bender from the bender.

The fiber yarn supplier may include multiple first rollers on which a carbon fiber or glass fiber yarn is wound, and a first stand in which the multiple first rollers are stacked at regular intervals.

The nonwoven fabric supplier may include multiple second rollers on which glass fiber nonwoven fabric is wound, and a second stand in which the multiple second rollers are stacked at regular intervals.

The resin impregnation die may include: an upper block having an upper impregnation space therein and having an upper resin injection hole and first side resin injection holes that are connected to the upper impregnation space; a lower block having a lower impregnation space therein and having a lower resin injection hole and second side resin injection holes that are connected to the lower impregnation space; and a mandrel positioned to be movable between the upper impregnation space of the upper block and the lower impregnation space of the lower block.

Further, a material feed guide block making the same planes with a front and a top of the upper block may be integrally formed at a front end portion of the mandrel.

Further, an upper material feed hole connected to the upper impregnation space may be formed between a topside of the guide block and a topside of the upper block, and a lower material feed hole connected with the lower impregnation space may be formed between an underside of the guide block and a topside of the lower block.

Further, a position sensor configured to transmit a detection signal of a position of the mandrel to a controller may be mounted at a predetermined position on the mandrel.

In particular, the controller may be configured to control a driving speed of resin supply pumps respectively connected to the upper resin injection hole, the first side resin injection holes, lower resin injection hole, and the second side resin injection holes on the basis of a detection signal of the position sensor such that resin pressures, which are injected into the upper resin injection hole, the first side resin injection holes, lower resin injection hole, and the second side resin injection holes, are differently adjusted.

The pultrusion molding die may include an upper die having an upper cavity formed on an underside and a lower die having a lower cavity formed on the topside, and is configured to apply heat and pressure to the composite material impregnated with resin and discharged from the resin impregnation die when the composite material impregnated with resin passes between the upper cavity and the lower cavity.

The bender may include: at least three or more roller rails arranged at regular intervals in a front-rear direction; a pair of rollers fastened to each of the roller rails to be movable left and right and configured to bend a product discharged from the pultrusion molding die; and an electronic cylinder mounted at each of both ends of each of the roller rails, connected to each roller of the pairs of rollers, and configured to move the pairs of rollers to the left or to the right in response to a control signal from a controller.

Further, the roller rails may include a first roller rail, a second roller rail, and a third roller rail arranged at regular intervals sequentially in the front-rear direction, and stress sensors configured to detect stress when a pair of rollers presses a product discharged from the pultrusion molding die may be mounted on the pair of rollers fastened to the second roller rail.

In particular, the controller may be configured to control a driving speed of the electric cylinders in order to increase or decrease a movement speed of the pair of rollers in a direction of bending the product on the basis of a detection signal of the stress sensor.

To this end, the controller may be configured to decrease the driving speed of the electric cylinder in order to decrease the movement speed of the pair of rollers when stress detected by the stress sensor exceeds a reference range, and may be configured to increase the driving speed of the electric cylinder in order to increase the movement speed of the pair of rollers when stress detected by the stress sensor is less than the reference range.

Further, the controller may be configured to maximally move backward piston rods of the electric cylinders such that each of the pair of rollers are maximally moved backward when the product finishes being bent into a car body part having a curvature.

The extractor may include: an upper clamp and a lower clamp configured to a front end portion of the car body part having a curvature; a fixed frame mounted at both sides of the lower clamp and positioned over the upper clamp; an elevation cylinder connected between the fixed frame and the upper clamp and configured to move up and down the upper clamp; guide rails to which a bottom of the lower clamp is fastened to be movable forward and backward; and a linear actuator fastened to the lower clamp and configured to move the lower clamp forward and backward.

In order to achieve the objectives, another embodiment of the present disclosure provides a method for pultrusion molding that includes: impregnating a composite material comprising a fiber yarn and nonwoven fabric with resin; molding the composite material impregnated with resin into a product having a preset cross-sectional shape by applying heat and pressure to the composite material; bending the product molded with a preset cross-sectional shape into a car body part having a curvature through a bender comprising at least three or more pairs of rollers arranged to be movable to the left and to the right; and pulling and extracting the bent car body product from the bender.

The bending may be implemented by moving the pairs of rollers in different directions after the product molded with a preset cross-sectional shape enters and is pressed between each of the pairs of rollers.

Another embodiment of the present disclosure may further include detecting stress when the pairs of rollers press the product molded with a preset cross-sectional shape by means of stress sensors mounted on the pairs of rollers.

Accordingly, a movement speed of the pairs of rollers in a direction of bending the product may be increased or decreased by control of a controller on the basis of a detection signal of the stress sensors.

To this end, when stress detected by the stress sensors exceeds a reference range, the movement speed of a pair of rollers may be decreased by a predetermined level by control of the controller, and when stress detected by the stress sensors is less than the reference range, the movement speed of a pair of rollers may be increased by a predetermined level by control of the controller.

The present disclosure provides the following effects through the objectives described above.

It is possible to manufacture straight car body parts through a process of impregnating a plastic composite material of two or more types materials with resin and a process of pultrusion-molding the plastic composite material impregnated with resin into a product having a preset shape by applying heat and pressure to the plastic composite material, and it is also possible to manufacture car body parts having a constant curvature of varying curvatures by making it possible to bend a product pultrusion-molded in a preset shape using at least three pairs of rollers.

Although the present disclosure was described above in detail through one embodiment, the scope of the present disclosure is not limited to the embodiment, and various changes and modifications by those skilled in the art using the spirit of the present disclosure defined in the following claims are also included in the scope of the present disclosure.

What is claimed is:

1. A pultrusion molding apparatus comprising:
a fiber yarn dispenser configured to supply a fiber yarn;
a nonwoven fabric dispenser configured to supply a nonwoven fabric;
a resin impregnation die forming an impregnation chamber therein, wherein one or more resin injection holes are formed through the resin impregnation die, and wherein the resin impregnation die is configured to:
receive the fiber yarn that is supplied from the fiber yarn dispenser and injected into the impregnation chamber;
receive the nonwoven fabric that is supplied from the nonwoven fabric dispenser and injected into the impregnation chamber;
receive, through the one or more resin injection holes, resin that is injected into the impregnation chamber; and
discharge a composite material, of the fiber yarn and the nonwoven fabric, that is impregnated with the resin;
a pultrusion molding die configured to:
apply heat and pressure to the composite material discharged from the resin impregnation die; and
mold and discharge the composite material into a first product having a predetermined cross-sectional shape;
a bender comprising a plurality of rollers arranged to be movable laterally with respect to a direction of discharge of the first product from the pultrusion molding die, wherein the bender is configured to bend, using the plurality of rollers, the first product discharged from the pultrusion molding die into a second product having a curvature; and
an extractor configured to pull and extract, from the bender, the second product.

2. The pultrusion molding apparatus of claim 1, wherein the fiber yarn dispenser comprises:
one or more rollers on which at least one of a carbon fiber yarn or a glass fiber yarn is wound; and
a stand on which the one or more rollers are stacked.

3. The pultrusion molding apparatus of claim 1, wherein the nonwoven fabric dispenser comprises:
one or more rollers on which glass fiber nonwoven fabric is wound; and
a stand on which the one or more rollers are stacked.

4. The pultrusion molding apparatus of claim 1, wherein the resin impregnation die comprises:
an upper block forming an upper impregnation chamber, of the impregnation chamber, therein, wherein the one or more resin injection holes comprise an upper resin injection hole and a first side resin injection hole that are formed on the upper block and connected to the upper impregnation chamber;
a lower block forming a lower impregnation chamber, of the impregnation chamber, therein, wherein the one or more resin injection holes comprise a lower resin injection hole and a second side resin injection hole that are formed on the lower block and connected to the lower impregnation chamber; and
a mandrel positioned to be movable between the upper impregnation chamber of the upper block and the lower impregnation chamber of the lower block.

5. The pultrusion molding apparatus of claim 4, wherein the mandrel comprises a material feed guide block that is flush with at least one side of the upper block.

6. The pultrusion molding apparatus of claim 5, wherein an upper material feed hole, connected to the upper impregnation chamber, is formed between a top surface of the material feed guide block and a top surface of the upper block, and
wherein a lower material feed hole, connected to the lower impregnation chamber, is formed between a bottom surface of the material feed guide block and a top surface of the lower block.

7. The pultrusion molding apparatus of claim 4, further comprising:
a controller; and
a position sensor mounted on the mandrel,
wherein the position sensor is configured to transmit, to the controller, a detection signal indicating a position of the mandrel.

8. The pultrusion molding apparatus of claim 7, wherein the controller is configured to:
control, based on the detection signal received from the position sensor, a driving speed of a plurality of resin supply pumps that are respectively connected to the upper resin injection hole, the first side resin injection hole, the lower resin injection hole, and the second side resin injection hole, such that resin pressures, for injecting the resin into the upper resin injection hole, the first side resin injection hole, the lower resin injection hole, and the second side resin injection hole, are independently adjusted.

9. The pultrusion molding apparatus of claim 1, wherein the pultrusion molding die comprises:
an upper die forming an upper cavity below the upper die; and
a lower die forming a lower cavity above the lower die, and
wherein the pultrusion molding die is configured to apply, while the composite material impregnated with the resin passes through the upper cavity and the lower cavity, heat and pressure to the composite material impregnated with the resin.

10. The pultrusion molding apparatus of claim 1, wherein the bender further comprises:
a plurality of roller rails successively arranged in the direction of discharge of the first product, wherein a pair of rollers, of the plurality of rollers, are fastened to each roller rail of the plurality of roller rails to be movable along the roller rail; and
a plurality of electric cylinders, each electric cylinder, of the plurality of electric cylinders, being:
mounted at each end of each of the plurality of roller rails;
connected to a corresponding roller, of the plurality of rollers; and
configured to move, based on a control signal received from a controller, the corresponding roller along a corresponding roller rail of the plurality of roller rails.

11. The pultrusion molding apparatus of claim 10, further comprising a controller,
wherein the plurality of roller rails comprise a first roller rail, a second roller rail, and a third roller rail,
wherein the second roller rail is arranged between the first roller rail and the third roller rail,
wherein the bender further comprises one or more stress sensors mounted on the pair of rollers fastened to the second roller rail, and
wherein the one or more stress sensors are configured to:
measure an amount of stress exerted by the pair of rollers against the first product discharged from the pultrusion molding die; and
transmit, to the controller, a signal indicating the amount of the stress.

12. The pultrusion molding apparatus of claim 11, wherein the controller is configured to control, based on the signal from the one or more stress sensors, a driving speed of the plurality of electric cylinders to adjust a movement speed of the pair of rollers in a direction of bending the first product.

13. The pultrusion molding apparatus of claim 12, wherein the controller is further configured to perform at least one of:
based on the amount of the stress indicated by the signal from the one or more stress sensors exceeding a reference range, decreasing the driving speed of the plurality of electric cylinders to decrease the movement speed of the pair of rollers; or
based on the amount of the stress indicated by the signal from the one or more stress sensors being less than the reference range, increasing the driving speed of the plurality of electric cylinders to increase the movement speed of the pair of rollers.

14. The pultrusion molding apparatus of claim 12, wherein the plurality of electric cylinders comprise piston rods, and wherein the controller is further configured to maximally move backward the piston rods such that each roller of the pair of rollers is maximally moved backward at a time that the first product finishes being bent into the second product having the curvature.

15. The pultrusion molding apparatus of claim 1, wherein the extractor comprises:
an upper clamp and a lower clamp configured to clamp a first portion of the second product;
a fixed frame mounted at both sides of the lower clamp and positioned over the upper clamp;
an elevation cylinder connected between the fixed frame and the upper clamp and configured to move up and down the upper clamp;
guide rails to which a bottom of the lower clamp is fastened to be movable; and
a linear actuator fastened to the lower clamp and configured to move the lower clamp.

16. A method performed by a pultrusion molding machine, the method comprising:
impregnating, with resin, a composite material comprising a fiber yarn and nonwoven fabric;
molding the composite material impregnated with the resin, by applying heat and pressure to the composite material impregnated with the resin, into a first product having a predetermined cross-sectional shape;
bending, using a bender comprising a plurality of rollers arranged to be movable laterally, the first product, molded to have the predetermined cross-sectional shape, into a second product having a curvature; and
pulling and extracting, from the bender, the second product.

17. The method of claim 16, wherein the bending comprises, after the first product, molded to have the predetermined cross-sectional shape, passes between the plurality of rollers and is pressed between the plurality of rollers, moving the plurality of rollers in different directions.

18. The method of claim 16, further comprising:
measuring, via one or more stress sensors mounted on the plurality of rollers, an amount of stress exerted by the plurality of rollers against the first product.

19. The method of claim 18, further comprising:
controlling, via a controller and based on the amount of stress indicated by a signal received from the one or more stress sensors, a movement speed of the plurality of rollers in a direction of bending the first product.

20. The method of claim 19, further comprising one of:
controlling, via the controller and based on the amount of the stress indicated by the signal received from the one or more stress sensors exceeding a reference range, the movement speed of the plurality of rollers to be decreased by a predetermined level; or
controlling, via the controller and based on the amount of the stress indicated by the signal received from the one or more stress sensors being less than the reference range, the movement speed of the plurality of rollers to be increased by the predetermined level.
